(19) United States
(12) Patent Application Publication
(10) Pub. No.: US 2007/0095431 A1
(43) Pub. Date: May 3, 2007

(54) Method and apparatus for a cutting tooth

(76) Inventor: Alan E. Cummings, San Marcos, TX (US)

Correspondence Address: JOHN VIRA, 326 Hackberry St., Lockhart, TX, 78644, US

(21) Appl. No.: 11/266,524

(22) Filed: Nov. 3, 2005

(51) Int. Cl. B27G 13/00; B27C 1/00; B27C 5/00

(52) U.S. Cl. 144/218

(57) ABSTRACT

A brush reducing system includes a power source and a brush reducing device that includes a rotating drum assembly having an engagement plate disposed on an outer periphery. The engagement plate is permanently affixed to the drum, and includes a radial engagement face and a horizontal engagement face for supporting a tooth element that registers in an attack position. The engagement plate further includes a restraint aperture. The tooth element includes a body having a first engagement face and a second engagement face. The first and second engagement faces are complementary to the radial engagement face and the horizontal engagement face of the engagement plate. A first leg and a second leg each include a restraint aperture complementary in size and location to the restraint aperture of the engagement plate for receiving a restraint pin may be inserted proper registration of the tooth element.

### BACKGROUND OF THE INVENTION

1. Field of the Invention

The present invention relates to rotating brush grinding equipment and, more particularly, but not by way of limitation, to methods and an apparatus for registering a tooth element onto an engagement plate, such that the tooth element registers in an attack position.

2. Description of the Related Art

In the areas of brush clearing and brush reducing, it is often desirable to engage a brush, shred the brush, and discharge the shredded brush onto the ground directly beneath an engagement portion of a brush-reducing device. The ability to discharge the shredded portions onto the ground essentially eliminates the necessity to remove the cleared brush from the work site, as well as any disposal costs normally associated with removal of the brush.

On a current design of a brush-reducing device, a drum including holder supports is rotated, and raised to engage the brush. Each holder support engages and restrains a single tooth holder housing cutting teeth. The tooth holders each include two legs, and each leg includes a restraint aperture. On assembly, the legs straddle the holder supports upon alignment of the apertures in the legs with an aperture in the holder support. A fastener is then passed through the aligned apertures to restrain the tooth holder in a rotatable position. The fastener is then secured with a nut to restrain the tooth holder in the rotatable position.

While the design of the holder support does include a stop for the rotating tooth at an attack position, one of ordinary skill in the art will recognize that rotation of loose fitting components may be problematic, as high-speed machinery can produce significant inertial forces, and subsequent increased impact loading. The brush-reducing devices routinely impact hidden objects, including discarded railroad rails, pipes, and fencing, thereby providing varying loads and impact forces on the brush-reducing device.

Rotation of the tooth holder may be eliminated by tightening the fastener and nut to compress the legs of the tooth holder against the holder support. However, the compressing of cast iron legs more than a slight distance is not a routine operation, and therefore, requires excessive torques, at least two operators, and a leverage pipe. One of ordinary skill in the art will further recognize that operators in a brush reducing crew work in remote sites, and are often alone. Should one operator be required to change a tooth holder immediately, at least two operators are forced to address the problem.

### SUMMARY OF THE INVENTION

In accordance with the present invention, a brush reducing system includes a power source and a brush reducing device. The power source may include hydraulic power system, a mechanical power takeoff, or the like, and may be coupled to the brush reducing device. The power source may further include a means for raising and lowering the brush reducing device, and a means for adjusting the angle of the brush reducing device.

The brush reducing system includes a hydraulically powered or mechanically driven rotating drum assembly that contains at least one engagement plate disposed on an outer periphery of a rotating drum. The engagement plate is permanently affixed to the rotating drum, and includes a cutout bounded by a radial engagement face and a horizontal engagement face. The radial engagement face is substantially perpendicular to the horizontal engagement face, such that they engage and support a tooth element. The engagement plate further includes a restraint aperture.

The tooth element includes a body having a first engagement face, a second engagement face, a first leg, a second leg, and protrusions representing teeth. The first and second engagement faces are substantially perpendicular to each other, and are complementary to the relationship between the radial engagement face and the horizontal engagement face of the engagement plate. The first leg and the second leg each include a restraint aperture complementary in size and location to the restraint aperture of the engagement plate.

Further described is a method for installing the tooth element including the first engagement face and the second engagement face, wherein the first engagement face interfaces with the radial engagement face of the engagement plate, and the second engagement face interfaces with the horizontal engagement face of the engagement plate. Upon correct registration, the restraint apertures of the legs and the engagement plate align, and a restraint pin may be inserted into the aligned restraint apertures, thereby restraining the tooth element in an attack position. A method for utilizing the brush reducing system is further disclosed.

It is therefore an object of the present invention to provide a brush reducing system including a brush reducing device utilizing tooth element being registered by a first engagement face and a second engagement face.

It is a further object of the present invention to provide a brush reducing device utilizing a tooth element that is registered and supported with a first engagement face and a second engagement face.

It is still further an object of the present invention to provide a tooth element including a first engagement face and a second engagement face for registration with an engagement plate.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1a provides an isometric view of a brush reducing system according to a first embodiment.

FIG. 1b provides an isometric view of a brush reducing device according to the first embodiment.

FIG. 1c provides an isometric view of a drum assembly according to the first embodiment.

FIG. 2 provides a side view of an engagement plate according to the first embodiment.

FIG. 3a provides a side view of a tooth element according to the first embodiment.

FIG. 3b provides a front view of the tooth element according to the first embodiment.

FIG. 3c provides a section view of the tooth element according to the first embodiment.

FIG. 4 provides a flowchart illustrating a method for installing a tooth holder element onto an engagement plate according to the first embodiment.

FIG. 5a provides an isometric view of the tooth element installed and restrained in an attack position according to the first embodiment.

FIG. 5b provides a frontal view of the tooth element in the registered position according to the first embodiment.

FIG. 5c provides section view of a tooth element installed onto an engagement plate in an attack position according to the first embodiment.

FIG. 6 provides a flowchart illustrating the method steps for utilizing the brush reducing system according to the first embodiment.

FIG. 7a provides a side view of a tooth element including a channel according to a second embodiment.

FIG. 7b provides a side view of a tooth element with teeth disposed within the channel according to the second embodiment.

FIG. 7c provides an isometric view of a tooth according to the second embodiment.

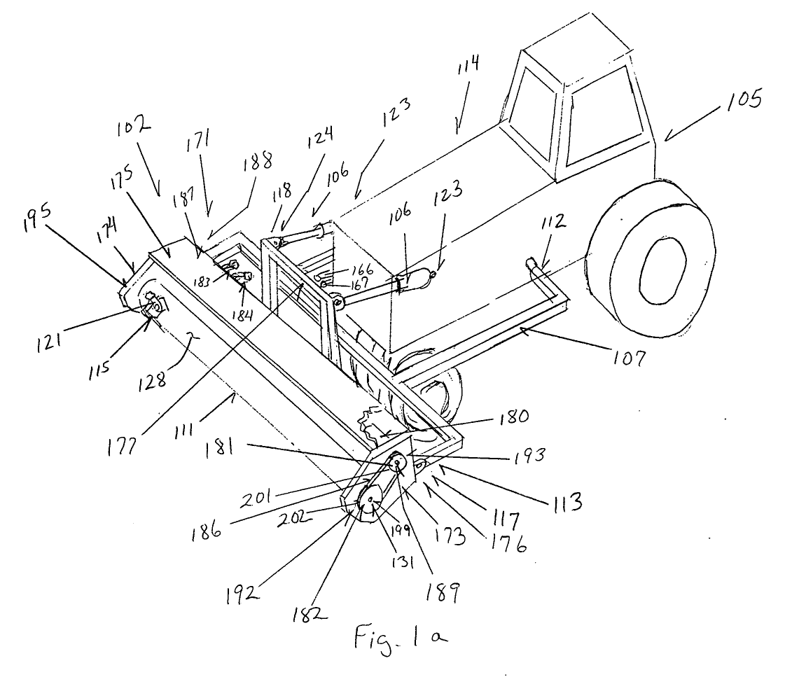

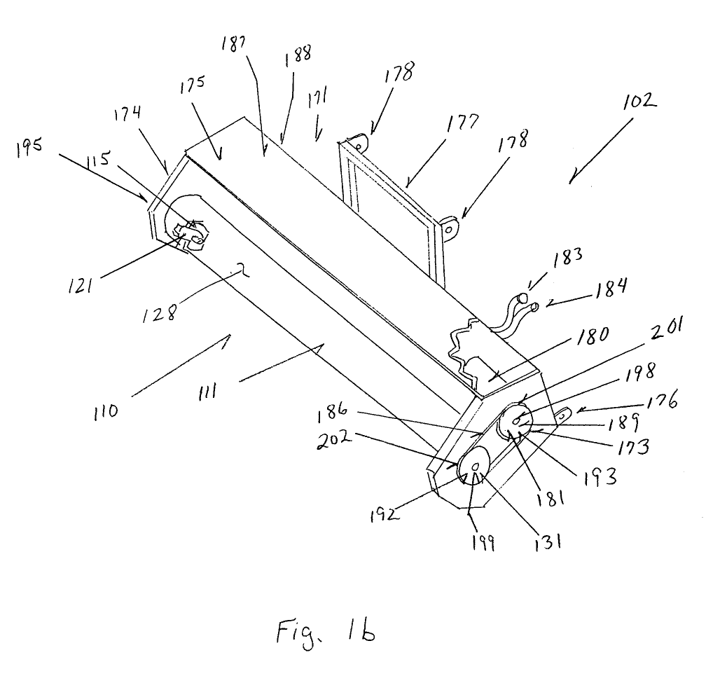

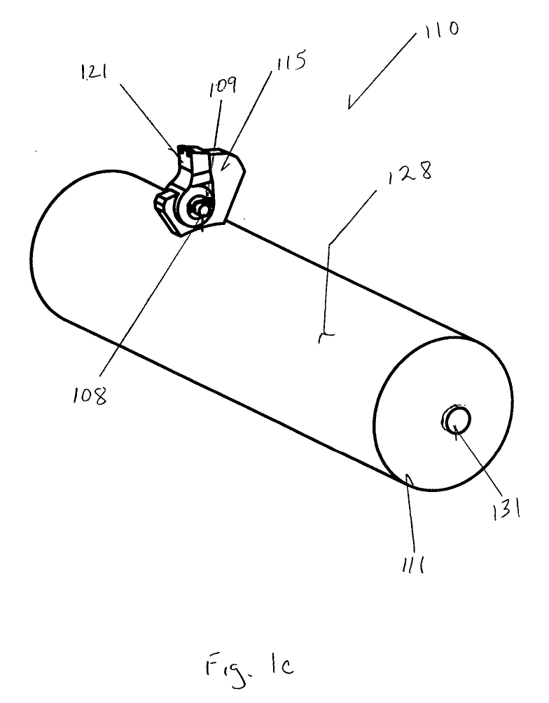

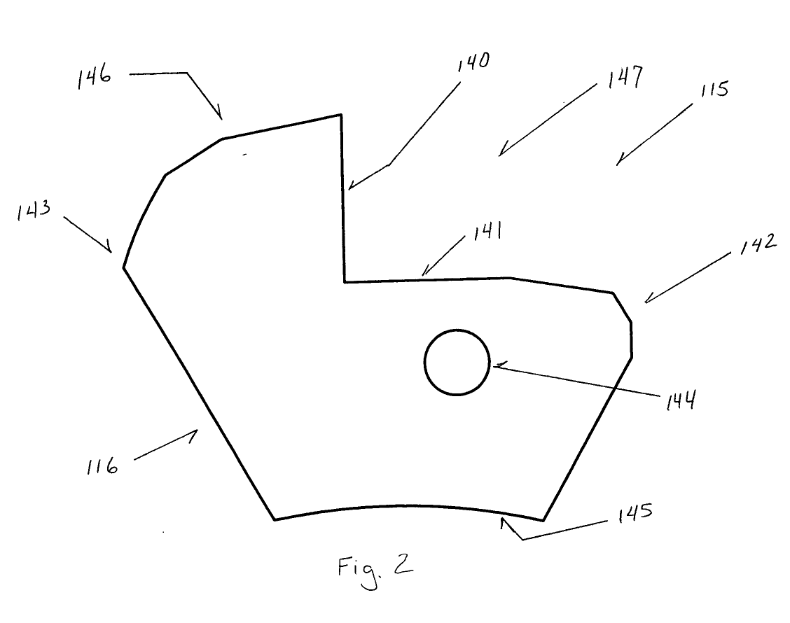

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

A brush reducing system 100 includes a power source 105, and a brush reducing device 102. In this embodiment, the power source 105 is mobile, such that the brush reducing device 102 may be transported to an area having brush. The power source 105 may be any form of service vehicle including, tractors, bulldozers, and the like, that is capable of articulating the brush reducing device 102 on an articulating framework. Typically, a brush reducing device 102 is mounted to a tractor designed for the forestry industry, wherein the tractor includes a vertical articulation, and a rotation articulation. One of ordinary skill in the art will recognize that most mobile power sources 105 include a power take off or a hydraulic power system to power connectable devices. In this embodiment, the power source 105 is a tractor having a hydraulic power system 114, a vertical articulation framework 107, and attack angle articulation arms 106. The vertical articulation framework 107 may be any form of mechanical extension suitable for raising and lowering components, and includes a first end 112 connectable to the hydraulic power system 114, and a second end 113 having lower connection points 117 suitable for attachment to tools, including the brush reducing device 102. In this embodiment, the vertical articulation framework 107 is constructed from steel for high loading capability.

The attack angle articulating arms 106 include a first end 123 connectable to the hydraulic power system 114, and a second end 124 including upper connection points 118. The second ends 113 may be connected to a device through the use of hinge pins, bolts, shafts, and the like, such that the connected device rotates about the lower connection points 117. The attack angle articulation arms 106 may extend and retract due to hydraulic power, thereby rotating a connected device about the lower connection points 117 at the second ends 113 of the vertical articulation framework 107.

The brush reducing device 102 includes a frame assembly 171 and a drum assembly 110. The frame assembly 171 includes a several horizontal members, an upper support 177, a first endplate 173, and a second endplate 174. The horizontal members are parallel to each other, and are disposed between the first endplate 173 and the second endplate 174. The endplates 173 and 174 are planar in shape, and of a same shape and thickness. The endplates 173 and 174 are further aligned with each other. The first end plate 173 includes a first shaft aperture 192 and a second shaft aperture 193. The second end plate 174 includes at least one shaft aperture 195 that lies in alignment with the first shaft aperture 192 of the first end plate 173. The horizontal members and the end plates 173 and 174 may be constructed from steel for increased strength. The frame assembly 171 may be a welded structure, such that the frame assembly 171 has a uniform strength. The upper support 177 includes a pair of upper attachment points 178 for connection to control components. The upper support 177, likewise, is constructed from a steel, and is welded to the horizontal members of the frame assembly 171. The frame assembly 171 further includes lower attachment points 176 for connection to control components.

The brush reducing device 102 may further include a driver 180 coupled to the first end plate 173. In this embodiment, the driver 180 is a hydraulic motor that includes a shaft 189 that passes through the second aperture 193 of the first end plate 173 to engage a drive pulley 181. The drive pulley 181 includes a belt groove 201, and an aperture 198 complementary to an outer diameter of the motor shaft 189, such that the pulley 181 rotates with the shaft 189 when the driver 180 is powered. The drum assembly 110 includes a drum 111 disposed about a shaft 131. The drum assembly 110 is disposed between the endplates 173 and 174, such that the shaft 131 extends through the first shaft aperture 192 of the first end plate 173, and the shaft aperture 195 of the second end plate 174. The brush reducing device 102 further includes a driven pulley 182 including a shaft aperture 199 and a belt groove 202. The shaft aperture 199 of the driven pulley 182 is of a size complementary to an outer diameter of the shaft 131. The shaft aperture 199 of the driven pulley 182 is secured onto the shaft 131 of the drum assembly 110, such that the driven pulley 182 rotates with the shaft 131. The brush reducing device 102 further includes a belt 186 that fits into the grooves 201 and 202 of the pulleys 181 and 182, such that the pulleys 181 and 182 rotate together.

The brush reducing device 102 further includes a shroud 175 disposed onto a top side 187 and a rear portion 188 of the brush reducing device 102 to close out the engagement area. In this first embodiment, the brush reducing device 102 includes a hydraulic supply hose 183 and a return hose 184 for coupling to the power source 105.

The drum assembly 110 includes the cylindrically shaped drum 111 and the shaft 131. The drum assembly 110 further includes at least one engagement plate 115 disposed on an outer periphery 128 of the drum 111. The at least one engagement plate 115 is permanently affixed to the drum 111 using any suitable means, including welding, mechanical fasteners, and the like. The engagement plates 115 include a planar body 116, a fixed end 145, a radial end 146, a cutout 147, a leading end 142, and a trailing end 143. The fixed end 145 is the end that is attached to the outer periphery 128 of the drum 111, and includes a portion complementary in shape to the curved outer periphery 128. The radial end 146 of the engagement plate 115 stands furthest away from the outer periphery 128 of the drum 111 when the engagement plate 115 is attached to the drum 111. The cutout 147 is bounded by a horizontal engagement face 141 and a radial engagement face 140. The leading end 142 is nearest the open end of the cutout 147, and the engagement plate 115 is oriented such that the leading end 142 points toward a direction of rotation of the drum assembly 110. The trailing end 143 lies opposite of the leading end 142, and therefore, follows the leading end 142 during rotation of the drum assembly 110 during use.

The engagement plate 115 includes a restraint aperture 144 that is disposed perpendicular to the planar body 116, and at a prescribed distance from the horizontal engagement face 141. Illustratively, a center of the restraint aperture 144 is approximately two inches from the fixed end 141. The horizontal engagement face 141 passes through a plane perpendicular to the planar body 116, and is located at a prescribed distance from the center of the restraint aperture 144. In this embodiment, the horizontal engagement face 141 is approximately one and a quarter inches from the center of the restraint aperture 144. The radial engagement face 140 is disposed substantially perpendicular to the horizontal engagement face 141, and at a prescribed distance from the center of the restraint aperture 144. In this embodiment, the radial engagement face 140 is approximately an inch and a half from the center of the restraint aperture 144. The engagement plates 115 are then positioned onto the outer periphery 128 of the drum 111 with the planar body 116 lying perpendicular to the drum 111, and the leading end 142 pointing in the rotation direction. Multiple engagement plates 115 may then be fabricated to the same design, and affixed to the drum 111, thereby fully outfitting the drum 111. The at least one engagement plate 115 may be constructed from any material suitable to withstand high loading during operation, and the hostile environment experienced by all outdoor equipment. Illustratively, the drum 111 and any engagement plates 115 may be constructed from steels, or other high strength material. The drum 111 and the at least one engagement plate 115 may be treated to minimize corrosion.

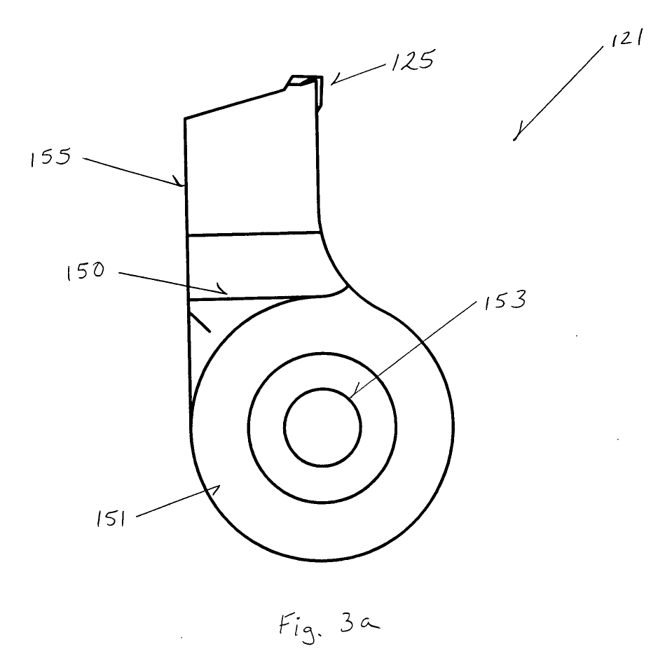

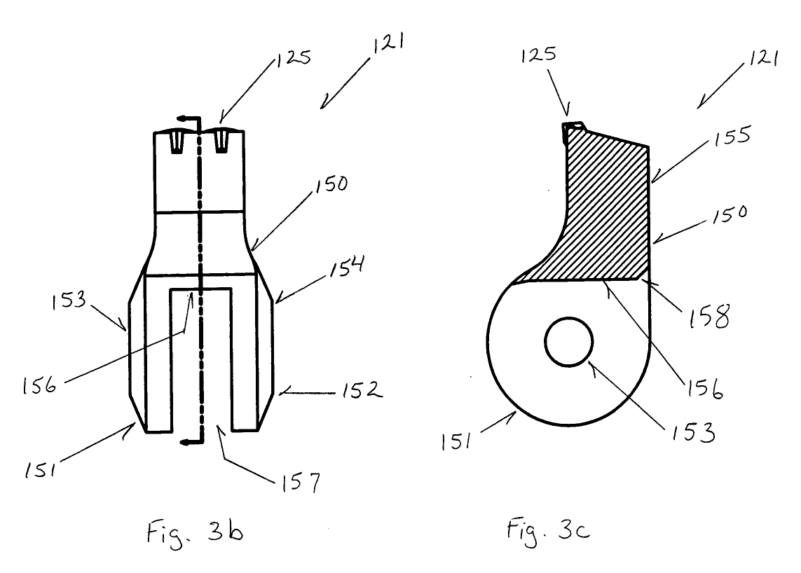

The drum assembly 110 further includes a tooth element 121 disposed on each respective engagement plate 115. The tooth element 121 includes a body 150, a first leg 151, a second leg 152, a first engagement face 155, and a second engagement face 156. The body 150 is of a rectangular shape and of a width greater than the width of the engagement plates 115. The first leg 151 is of a disk shape, and includes a first restraint aperture 153, substantially central to the disk shape of the first leg 151. The diameter of the disk is sized such that a first engagement face 155 is tangentially aligned with diameter of the disk. The second leg 152 is symmetrical to the first leg 151, and includes a second restraint aperture 154. The second leg 152 is disposed at a prescribed distance from the first leg 151, such that a cavity 157 is created between the first leg 151 and the second leg 152. The cavity 157 is slightly wider than the engagement plate 115, such that the engagement plate 115 fits between the first leg 151 and the second leg 152. The cavity 157 is further centrally located to the body 150, such that the tooth element 121 is substantially symmetrical through a midplane, as shown in FIG. 3b.

The first engagement face 155 is disposed on a trailing edge of the body 150, such that the body 150 may be supported at the first engagement face 155. The second engagement face 156 is disposed in the cavity 157, and is substantially perpendicular to the first engagement face 155. The tooth element 121 may further include a relief 158. The relief 158 may be any form of relief, including a chamfer, groove, step, or the like, such that the first engagement face 155 and the second engagement face 156 are not required to meet within a tight tolerance window. The body 150 further includes protrusions 125 representative of teeth. The body 150 is of a thickness slightly larger than the width of an engagement plate 115.

The drum assembly 110 may further include a restraint pin 108 and a restraint lock 109. The restraint pin 108 may be any form of restraint device that can withstand the high loads associated with the operation of the brush reducing device 102. The restraint lock 109 may be any form of locking device that may be utilized to hold an object in place, including wire restraints, nuts for threaded pins, or spring pins. In this embodiment, the restraint pin 108 is a pin including a head 211 and a lock aperture 210. The restraint lock 109 is a complementary cotter pin. The restraint pin 108 and the restraint lock 109 are utilized to hold the tooth element 121 onto the engagement plate 115 in an attack position.

On assembly of the brush reducing device 102, the engagement plates 115 are secured onto the outer periphery 128 of the drum assembly 110. The tooth element 121 may then be placed onto the engagement plate 115 such that the horizontal engagement face 141 of the engagement plate 115 enters the cavity 157, and the protrusion 125 is facing toward the leading edge 142 of the engagement plate 115. After straddling, the first engagement face 155 of the tooth element 121 is mated to the radial engagement face 140 of the engagement plate 115. Once mated, the tooth element 121 may be moved downward along the radial engagement face 140 until the second engagement face 156 of the tooth element 121 contacts the horizontal engagement face 141 of the engagement plate 115. Once the first and second engagement faces 155 and 156 are properly registered, the first and second restraint apertures 153 and 154 are aligned with the restraint aperture 144 of the engagement plate 115, and the restraint pin 108 may then be inserted through the first restraint aperture 153 of the first leg 151, the restraint aperture 144 of the engagement plate 115, and the second restraint aperture 154 of the second leg 152 to secure the tooth element 121 in the attack position. Once inserted, the restraint lock 109 may be installed to prevent the possibility of components becoming free during operation.

The mating of the first engagement face 155 with the radial engagement face 140, and the second engagement face 156 with the horizontal engagement face 141 of the engagement plate 115 provides two substantially perpendicular points of engagement, and further locates the restraint apertures 153, 154, and 144. After insertion of the restraint pin 108, the tooth element 121 is supported at two different points, and is held in place by the restraint pin 108, and therefore, is unable to rotate about the restraint pin 108. Use of the self-locating tooth element 121 thereby eliminates the need to compress the legs 151 and 152 to contact the engagement plate 115, as the tooth element 121 is properly located in a ready-for-use position when the first and second engagement faces 155 and 156 are properly mated.

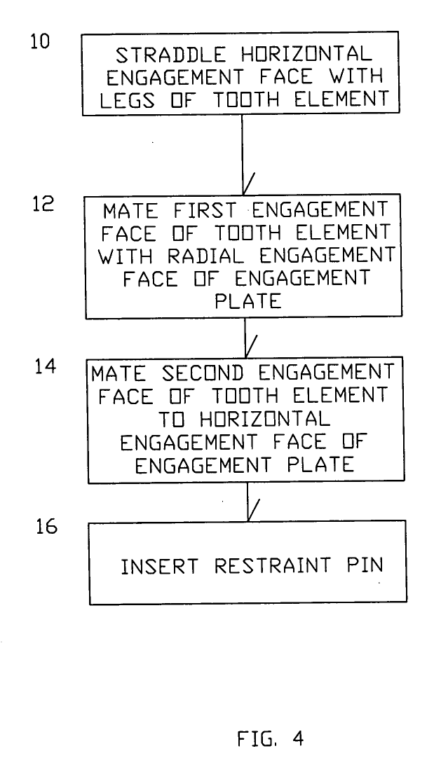

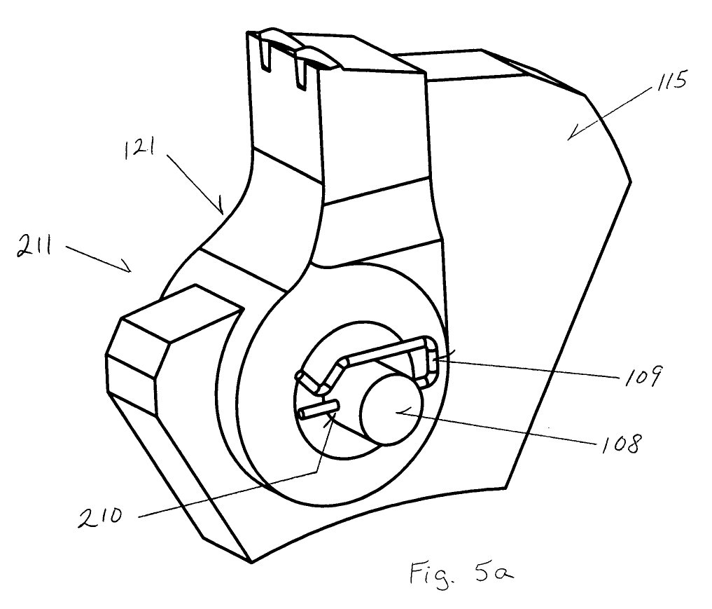

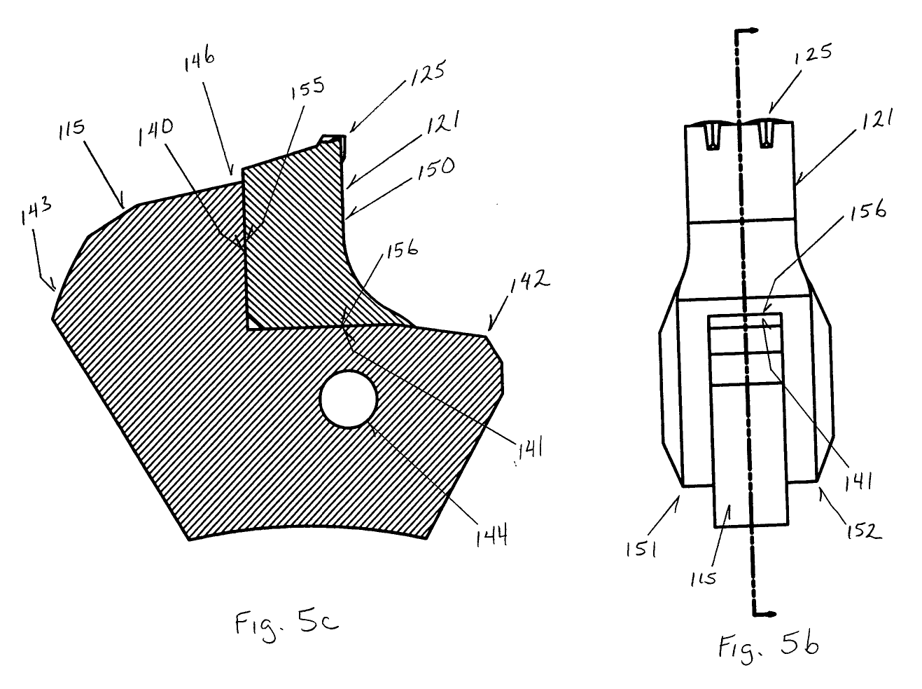

As shown in the method flowchart of FIG. 4, the process of installing a tooth element 121 onto an engagement plate 115 commences with step 10, wherein the tooth element 121 is lowered to the engagement plate 115, such that the first and second legs 151 and 152 straddle the horizontal engagement face 141. The process continues with the mating of the first engagement face 155 of the tooth element 121 to the radial engagement face 140 of the engagement plate 115, step 12. Step 14 provides mating the second engagement face 156 of the tooth element 121 to the horizontal engagement face 141 of the engagement plate 115. Once both engagement faces 155 and 156 are registered onto the engagement faces of the engagement plate 115, the restraint apertures 153 and 154 are aligned with the restraint aperture 144. The restraint pin 108 may then be inserted into through the restraint apertures 153, 144, and 154, such that the tooth element 121 is restrained in the attack position, as shown in step 16. While this embodiment has been shown with the steps of mating a first engagement face 155 and a second engagement face 156, one of ordinary skill in the art will recognize that various alternatives may exist for accomplishing the mating of a first face and a second face. Illustratively, a first face may be mated to a prescribed contact face, and a second point of registration may contact a second prescribed contact face, thereby creating two suitable points of registration.

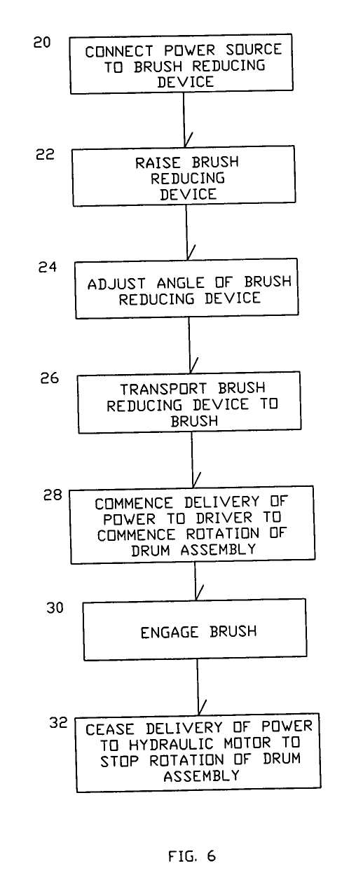

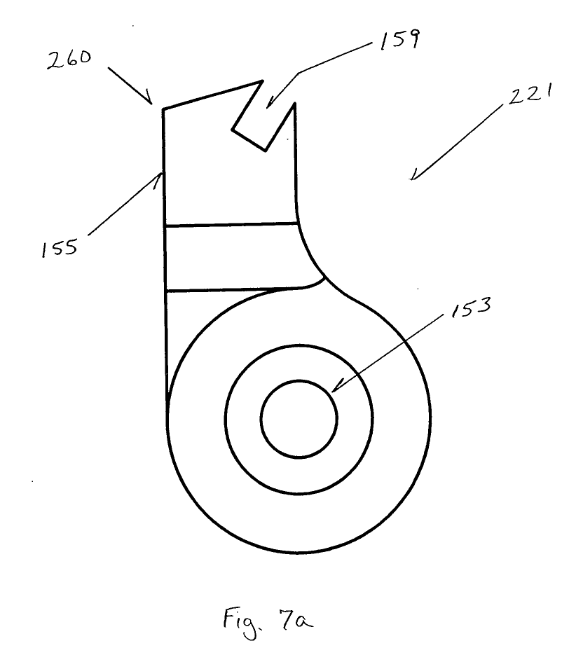

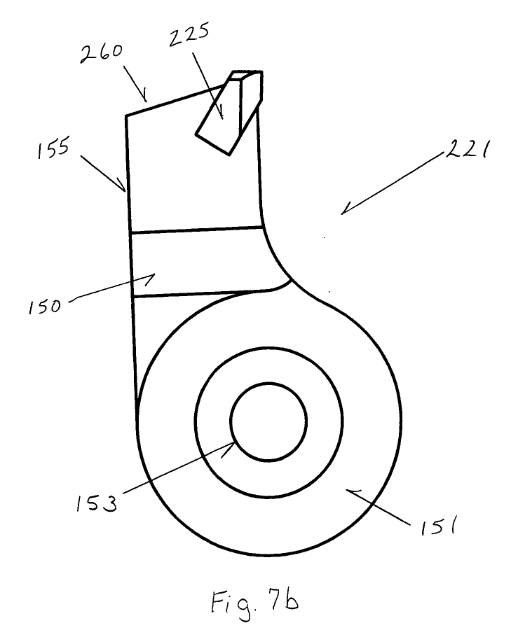

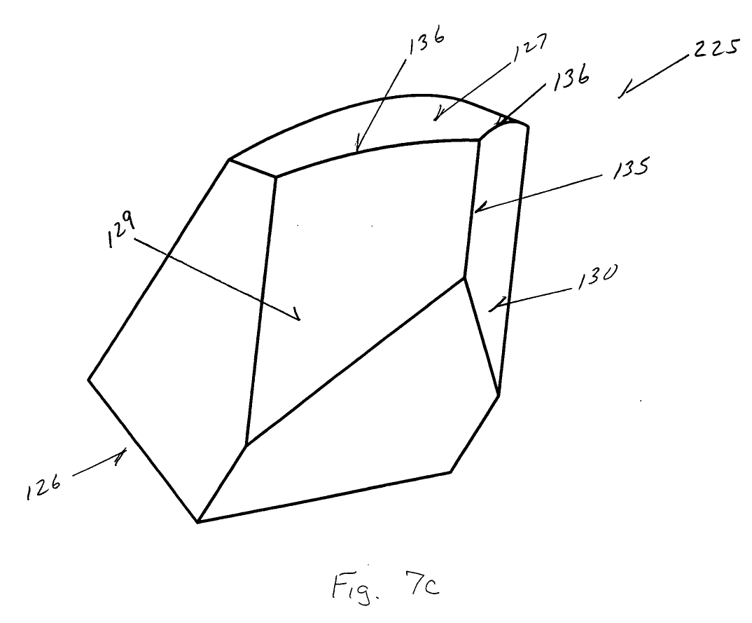

Once at least one tooth element 121 has been installed onto the at least one engagement plate 115, the brush reducing device 102 is ready for connection to a power source. As shown in FIG. 6, a method of using the brush reducing system 100 commences with step 20, wherein the power source 105 is connected to the brush reducing device 102 by attaching the lower connection points 117 of the vertical articulation framework 107 to the lower attachment points 176 of the brush reducing device 102. Next, the upper connection points 118 of the attack angle articulation arms 106 are connected to the upper attachment points 178 of the brush reducing device 102. The hydraulic supply hose 183 must also be connected to the hydraulic output hose 166, and the hydraulic return hose 184 must be connected to the hydraulic input hose 167. Once connected, an operator may direct the power source 105 to raise the vertical articulation framework 107, thereby raising the brush reducing device 102 off of the ground, step 22. Once raised, the operator may direct the power source 105 to extend or retract the attack angle articulation arms 106, thereby forcing the brush reducing device 102 to rotate about the lower connection points 117, as shown in step 24. The operator may then transport the brush reducing device 102 to a brush reduction location, step 26. Upon arrival at the brush reduction location, the operator may deliver the power from the hydraulic power system 114 to the driver 180, thereby commencing the rotation of the hydraulic motor output shaft 189 and the drive pulley 181. The rotation of the drive pulley 181 forces the belt 186 to turn the driven pulley 182, and the shaft 131 of the drum assembly 110, step 28. The rotation of the drum assembly 110 causes the tooth element 121 to move with the drum assembly 110. The operator may then engage a brush in the path of the rotating tooth element 121 by moving the brush reduction device 102 upwards or downwards, as well as by rotating the attack angle of the brush reducing device 102, step 30. Upon completion of the desired brush reduction, the operator may cease the rotation of the drum assembly 110 by ceasing the flow of hydraulic fluid to the driver 180, step 32.

A second embodiment includes a tooth element 221 that is substantially identical to the tooth element 121, and accordingly, like parts have been numbered with like numerals. The tooth element 221 may be utilized in the brush reducing device 102 and the brush reducing system 100 in lieu of the tooth element 121. The tooth element 221 includes a channel 159 housing teeth 225 disposed at a leading end 260 of the tooth element 221. The channel 159 passes through the body 150 of the tooth element 221 in a direction parallel to the first restraint aperture 153, and is of a width complementary to a thickness of the teeth 225. The width of the body 150 is complementary to a width of two teeth 225.

The tooth 225 includes a rectangular body 126 having a first angled face 129 and a second angled face 130. The angled faces 129 and 130 are disposed at approximately one hundred and twenty degrees apart, and create an angled face leading edge 135. The tooth 225 further includes a rounded crown 127. A crown leading edge 136 is created where the angled faces 129 and 130 meet the rounded crown 127. The angled faces 129 and 130, and the crown leading edge 136 are the contact points for the tooth 225. The tooth 225 is disposed within the channel 159, such that the crown 127 of the tooth 225 extends slightly beyond the leading edge 260 of the tooth element 221. The teeth 225 are secured in the channel 159 with a silver solder filler. One of ordinary skill in the art will recognize that other means of restraint may be utilized to restrain the teeth 225, including mechanical restraints. In this embodiment the teeth 225 are constructed from carbide for increased strength.

On assembly, a pair of teeth 225 are oriented in the channel 159, such that the crown 127 protrudes from the tooth element 221, and the angled face leading edge 135 lies in a position substantially parallel to the first engagement face 155. Once soldered in place, the teeth 225 are continuously in an attack position, and require no further adjustment. As the teeth 225 are virtually never removed from the tooth element 221, the installation and removal of the tooth elements 121 and 221 are identical. All other aspects of the brush reducing device 200 are also identical to the brush reducing device 100, and therefore, will not further be disclosed.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A tooth element for a brush reducing device, comprising:
a body including a first engagement face and a second engagement face, wherein the first engagement face and the second engagement face register the tooth element in an attack position on a brush reducing device, and further wherein, the body includes protrusion representing teeth opposite the first engagement face for engaging brush.

2. The tooth element according to claim 1, wherein the first engagement face is substantially perpendicular to the second engagement face.

3. The tooth element according to claim 1, further comprising:
a channel disposed through the body, wherein the channel is disposed opposite to the first engagement face.

4. The tooth element according to claim 3, further comprising:
at least one tooth disposed within the channel, wherein the tooth protrudes from the channel, thereby engaging the brush when the tooth element is rotated in a brush area.

5. The tooth element according to claim 4, wherein the at least one tooth is soldered into the channel.

6. The tooth element according to claim 1, wherein the tooth element attaches to an engagement plate of a brush reducing device.

7. The tooth element according to claim 6, wherein the engagement plate is attached to a rotating drum from the rotating brush reducing device.

8. The tooth element according to claim 1, further comprising:
a first leg extending from the body, the first leg disposed on a first side of the second engagement face; and
a second leg extending from the body, and disposed symmetrically opposite from the first leg, wherein the second engagement face is disposed between the first and second legs, and further wherein, the first and second legs are utilized to restrain the tooth element in the registered position when coupled to the engagement plate.

9. The tooth element according to claim 8, wherein the first leg includes a first restraint aperture for receiving a restraint pin, and the second leg includes a second restraint aperture for receiving the restraint pin.

10. The tooth element according to claim 9, wherein the first restraint aperture and the second restraint aperture are collinear.

11. The tooth element according to claim 10, wherein the restraint apertures of the legs are aligned with a restraint aperture disposed in an engagement plate when the tooth element is in the registered position when coupled to the engagement plate.

12. The tooth element according to claim 11, wherein the registered position is an attack position.

13. A method of installing a non pivoting tooth element onto a rotating drum of a brush reducing device, comprising:
a. mating a first engagement face of a tooth element to a radial engagement face of an engagement plate disposed on a rotating drum of a brush reducing device, wherein the tooth element includes a body having legs, and further wherein each of the legs includes at least one restraint aperture;
b. mating a second engagement face of the tooth element to a horizontal engagement face of the engagement plate, such that the tooth element is registered in an attack position, wherein the restraint apertures of the legs are aligned with a restraint aperture in the engagement plate when the tooth element is properly registered; and
c. inserting a restraint pin through the aligned restraint apertures of the legs and the engagement plate, thereby restraining the tooth element in the registered attack position.

14. The method of claim 13, further comprising:
d. installing a restraint lock onto the restraint pin to prevent accidental disengagement of the restraint pin.

15. The method of claim 14, further comprising:
e. rotating the drum to engage brush with the tooth element.

16. A brush reducing device, comprising:
a drum coupled to a driver, the drum including an outer periphery and an axis of rotation;
at least one engagement plate disposed on the outer periphery of the drum, the at least one engagement plate including a horizontal engagement face, a radial engagement face, and a restraint aperture; and
at least one tooth element including a body having a first engagement face and a second engagement face, wherein the first engagement face mates with the radial engagement face of the at least one engagement plate, and the second engagement face mates with the horizontal engagement face of the at least one engagement plate to register the tooth element in an attack position, and further wherein, the drum rotates about its axis when power is supplied to the driver to engage a brush.

17. The brush reducing device according to claim 16, wherein the tooth element further comprises a first leg and a second leg that extend from the body on opposite sides of the first and second engagement faces, thereby straddling the at least one engagement plate.

18. The brush reducing device according to claim 17, wherein the first leg and the second leg include a first restraint aperture and a second restraint aperture, respectively.

19. The brush reducing device according to claim 18, wherein the first restraint aperture and the second restraint aperture are collinear.

20. The brush reducing device according to claim 19, wherein the first restraint aperture and the second restraint aperture are disposed at a predetermined distance from the second engagement face of the at least one tooth element.

21. The brush reducing device according to claim 20, wherein the at least one engagement plate further comprises a restraint aperture disposed at the predetermined distance from the horizontal engagement face.

22. The brush reducing device according to claim 21, wherein the first restraint aperture and the second restraint aperture align with the restraint aperture of the engagement plate when the tooth element is in the registered attack position.

23. The brush reducing device according to claim 22, further comprising:
a restraint pin that passes through the three aligned restraint apertures to restrain the tooth element in the attack position.

24. The brush reducing device according to claim 23, further comprising:
a restraint lock disposed onto the restraint pin to prevent accidental disengagement of the restraint pin and the tooth element.

25. The brush reducing device according to claim 16, wherein the tooth element further comprises protrusions representative of teeth disposed at a radial end for engaging brush.

26. The brush reducing device according to claim 16, wherein the tooth element further comprises a channel disposed at a radial end.

27. The brush reducing device according to claim 26, wherein the tooth element further comprises at least one tooth disposed within the channel, such that the teeth engage a brush when the drum is rotated.

28. The brush reducing device according to claim 16, wherein the drum rotates in a direction that pushes the tooth element against the radial engagement face of the engagement plate.

29. The brush reducing device according to claim 16, wherein the attack position is substantially radial to the drum assembly.

30. A brush reduction system, comprising:
a mobile power source;
a brush reducing device coupled to the power source, the brush reducing device including a drum assembly coupled to a driver, the drum assembly including at least one tooth element coupled to at least one engagement plate, wherein a first engagement face of the tooth element mates with a radial engagement face of the engagement plate, and the second engagement face of the tooth element mates with the horizontal engagement face of the engagement plate, thereby registering the tooth element in an attack position, and further wherein, the drum assembly is rotated when the driver is powered to engage the brush with the tooth element.

31. The brush reducing system according to claim 30, wherein the power source is a tractor including a hydraulic power system, a vertical articulation framework, and attack angle articulation arms.
